(19) United States
(12) Patent Application Publication
(10) Pub. No.: US 2017/0037930 A1
(43) Pub. Date: Feb. 9, 2017

(54) DEVICE FOR DAMPING TORSIONAL OSCILLATIONS

(71) Applicant: VALEO EMBRAYAGES, Amiens Cedex 2 (FR)

(72) Inventor: Franck CAILLERET, Amiens (FR)

(21) Appl. No.: 15/227,388

(22) Filed: Aug. 3, 2016

(30) Foreign Application Priority Data
Aug. 5, 2015 (FR) 1557542

(51) Int. Cl. F16F 15/14

(52) U.S. Cl. CPC F16F 15/145

(57) ABSTRACT

A device for damping torsional oscillations has a support rotatable around an axis, a plurality of pendulum assemblies, a plurality of rolling members with each rolling member interacting with a first and second raceways, and a plurality of interposition members. The support comprises a plurality of windows which two rolling members are received, one of those rolling members interacting with a second raceway integral with one of the pendulum assemblies, and the other of those rolling members interacting with a second raceway integral with another of those pendulum assemblies. Each interposition member is arranged in a window of the support, and each interposition member being movable with respect to each of the two pendulum assemblies. Each interposition member capable of coming into contact with the periphery of the window in which it is received, with one of the two pendulum assemblies, and with the other of the two pendulum assemblies.

### CROSS-REFERENCE TO RELATED APPLICATIONS AND CLAIM TO PRIORITY

This application is related to Patent Application No. 1557542 filed Aug. 5, 2015 in France, the disclosure of which is incorporated herein by reference and to which priority is claimed.

### FIELD OF THE INVENTION

The present invention relates to a device for damping torsional oscillations, in particular for a motor vehicle transmission system.

### BACKGROUND OF THE INVENTION

In such an application the device for damping torsional oscillations can be integrated into a torsional damping system of a clutch capable of selectively connecting the combustion engine to the gearbox, in order to filter vibrations due to irregularities of the engine.

As a variant, in such an application the device for damping torsional oscillations can be integrated into a friction disk of the clutch or into a hydrodynamic torque converter.

A device of this kind for damping torsional oscillations conventionally utilizes a support and one or more pendulum assemblies that are movable with respect to that support, the displacement of each pendulum assembly with respect to the support being guided by two rolling members each interacting on the one hand with raceways integral with the support, and on the other hand with raceways integral with the pendulum assemblies. Each pendulum assembly comprises, for example, two pendulum masses riveted to one another.

It is known to select the damping device, for example by way of the shape of the raceways, in such a way that it filters the excitation order of a two-cylinder combustion engine of the vehicle, also called “order 1,” the excitation order of a combustion engine being, in known fashion, the number of ignition events per crankshaft revolution of that engine. Such devices are highly sensitive to the force of gravity, which can then cause undesired displacements of the pendulum assemblies and thus affect the filtering performance.

In order to solve this problem it is known, for example from the application DE 10 2012 221 103, to provide springs between two circumferentially adjacent pendulum assemblies in such a way that the pendulum assemblies thus connected resist the force of gravity exerted on them in turn when a rotational motion is imparted to the device. Insertion of these springs involves configuring additional receptacles in the pendulum assemblies, or providing appropriate fastening means on those pendulum assemblies, which is costly and complex. In addition, insertion of the springs causes the appearance of an additional resonant frequency.

Insertion of the springs can also require the configuration of open cutouts in the support of the device, thus reducing deflection of the pendulum assemblies. It is furthermore necessary to dimension the springs correctly, and there is no guarantee that the springs' characteristics will be maintained over time.

### SUMMARY OF THE INVENTION

An object of the invention is to reduce the influence of gravity on the pendulum assemblies, in particular when the purpose of the latter is to filter the excitation order of the vehicle's two-cylinder combustion engine, while eliminating all or some of the disadvantages above.

The invention achieves this, according to one of its aspects, with the aid of a device for damping torsional oscillations, comprising:

at least one support capable of rotational displacement around an axis;

a plurality of pendulum assemblies, each pendulum assembly being movable with respect to the support;

a plurality of rolling members, each rolling member interacting with a first raceway integral with the support and with a second raceway integral with a pendulum assembly, the displacement of each pendulum assembly with respect to the support being guided by at least two of those rolling members; and

a plurality of interposition members,

the support comprising a plurality of windows in each of which two rolling members are received, one of those rolling members interacting with a second raceway integral with one of the pendulum assemblies, and the other of those rolling members interacting with a second raceway integral with another of those pendulum assemblies, said pendulum assemblies being circumferentially adjacent;

each interposition member being arranged in a window of the support and being movable with respect to each of the two pendulum assemblies whose displacement with respect to the support is guided by one of the two rolling members received in that window, each interposition member being capable of coming into contact

on the one hand with a region of the periphery of the window in which it is received,

on the other hand with a region of one of the two pendulum assemblies, and

on the other hand with a region of the other of the two pendulum assemblies.

The interposition member thus allows a minimum non-zero gap to exist continuously between those two pendulum assemblies. Impacts between those two pendulum assemblies, in particular due to gravity, are consequently prevented. The interposition member can be dimensioned so that the minimum gap thereby maintained continuously between the two pendulum assemblies limits the displacement thereof in response to gravity, and thus blocks the effect of gravity on the pendulum assemblies. As the support rotates, each pendulum assembly successively occupies the highest position around the rotation axis of the support, and the presence of the interposition members thus limits the downward displacement of that pendulum assembly in response to gravity.

Each interposition member is preferably arranged in a window angularly between the two rolling members received in that window.

According to the invention, each interposition member is freely displaceable in the window, that displacement being limited only by the occurrence of contact with the region of the periphery of the window, with the region of one of the two pendulum assemblies, and with the region of the other of the two pendulum assemblies. The interposition is thus different from a roller or wheel mounted freely rotatably on a shaft integral with the support, for example.

The interposition member can come into contact simultaneously with the region of the periphery of the window, with the region of one of the two pendulum assemblies, and with the region of the other of the two pendulum assemblies. This simultaneous contact between the interposition member and the aforementioned regions can occur for any position of the interposition member in the window. As a variant, this simultaneous contact occurs only in certain positions of the interposition member in the window, those positions corresponding, for example, to a deflection of the pendulum assemblies or to stoppage of the combustion engine of the device.

Each of the above contacts can be a rolling action, i.e. the interposition member can roll, simultaneously or not, on

the region of the periphery of the window in which it is received,

the region of one of the two pendulum assemblies, and

the region of the other of the two pendulum assemblies.

The cross section of the interposition members can be of the same shape as that of the rolling members. They are, for example, disks. The area of the cross section of an interposition member is, for example, equal to, greater than, or less than that of a rolling member.

Each interposition member has, for example, a circular cross section.

The interposition members can be implemented from materials other than those of the rolling members. For example, less rigid materials are used to implement the interposition members than to implement the rolling members.

For purposes of the present Application:

“axially” means “parallel to the rotation axis of the support”;

“radially” means “along an axis belonging to a plane orthogonal to the rotation axis of the support and intersecting that rotation axis of the support”;

“angularly” or “circumferentially” means “around the rotation axis of the support”;

“orthoradially” means “perpendicularly to a radial direction;” and

“integral” means “rigidly coupled.”

Again for purposes of the present Application, the inactive position of the device is the position thereof in which the pendulum assemblies are subjected to a centrifugal force but not to torsional oscillations deriving from irregularities of the combustion engine.

The center of gravity of each pendulum assembly can describe a curve upon its displacement with respect to the support in order to filter a torsional oscillation, and

the region of one of the two pendulum assemblies with which the interposition member comes into contact,

the region of the other of the two pendulum assemblies with which the interposition member comes into contact,

and, as appropriate, the portion of the periphery of the window with which the interposition member comes into contact

can each define a curve of the same family as the one described by the center of gravity of each pendulum assembly. For purposes of the present Application, two curves belong to the same family if they have the same parametric equation.

The shape of the first and second raceways can be such that each pendulum assembly is displaced with respect to the support

both in translation around a notional axis parallel to the rotation axis of the support, and also

rotationally around the center of gravity of said pendulum assembly, such a motion also being called a “combined motion” and being disclosed, for example, in the Application DE 10 2011 086 532.

This combined motion can be referred to as a “100% combined motion.” The term “100% combined motion” is used for a pendulum assembly when, with the device in the inactive position, in a plane perpendicular to the rotation axis, the line normal to the contact between a first raceway and one of the rolling members guiding the displacement of that pendulum assembly, and the line normal to the contact between another first raceway and the other of the rolling members guiding the displacement of that pendulum assembly, intersect on the rotation axis of the support.

In such an instance of 100% combined motion, the center of gravity of each pendulum describes in particular a circle, and the region of the edge of the window, and the edges of the regions of the pendulum, along which the interposition member rolls, are also circular. As a variant, the center of gravity can describe an epicycloid. It is furthermore possible for the regions of the pendulum assemblies along which the interposition member rolls to define straight lines.

As a variant, the shape of the aforementioned first and second raceways can be such that each pendulum assembly is displaced with respect to the support only in translation around a notional axis parallel to the rotation axis of the support.

That region of the periphery of the window of the support with which the interposition member comes into contact can belong to the radially external edge of the window. In that case the interposition member can then come into contact simultaneously with that region of the edge, with the region of one of the two pendulum assemblies, and with the region of the other of the two pendulum assemblies

when the device is inactive, and/or

as soon as a torsional oscillation is being filtered, or

intermittently while a torsional oscillation is being filtered.

The device can comprise an abutment damping member arranged radially between the radially internal edge of the window and the interposition member when the device is inactive, that abutment damping member being capable of compressing upon contact with that radially internal edge of the window. Two cavities can be configured in the radially internal edge of the window, each of these cavities having, for example, a dimension allowing it to accommodate the abutment damping member. More specifically, one of the cavities can accommodate the abutment damping member when the pendulum assemblies come into abutment against the support subsequent to a counter-clockwise displacement of those pendulum assemblies in order to filter a torsional oscillation, while the other cavity can accommodate the abutment damping member when the pendulum assemblies come into abutment against the support subsequent to a clockwise displacement of those pendulum assemblies in order to filter a torsional oscillation.

This abutment damping member is, for example, not integral either with the pendulum assemblies or with the support or with the interposition member. The abutment damping member is capable of coming into contact simultaneously with the radially inner edge of the window, with the interposition member, and with each pendulum assembly, in order to damp the abutment of those pendulum assemblies against the support. This abutment damping member can be freely displaceable in the window, its displacement within the window being, for example, limited only by the occurrence of contact with that edge of the window, with the pendulum assembly, and with the interposition member.

Each window can receive a single abutment damping member as mentioned above.

The abutment damping member is made, for example, of rubber or of an elastomer. The abutment damping member can have a cylindrical shape in cross section.

As appropriate, other means for damping the abutment of a pendulum assembly against the support are provided, these other means being, in particular, integral with the pendulum assembly.

In a variant, that region of the periphery of the window of the support with which the interposition member comes into contact belongs to the radially internal edge of that window. In this variant the interposition member can then come into contact simultaneously with that region of the edge, with the region of one of the two pendulum assemblies, and with the region of the other of the two pendulum assemblies

when the device is inactive, and/or

intermittently when a torsional oscillation is being filtered.

The radially internal edge of the window in which the interposition member is received can define a protrusion projecting radially into the window, and the interposition member can rest against that protrusion when the combustion engine of the vehicle is stopped. The shape of this protrusion, which can be rounded in a plane perpendicular to the rotation axis, can allow the interposition member to remain at a constant distance from the radially internal edge of the window as long as the adjacent pendulum assemblies are centrifuged and not desynchronized.

The presence of interposition members can allow the gap between two circumferentially adjacent pendulum assemblies to be continuously constant for all the pendulum assemblies of the device. More specifically, if three pendulum assemblies are present, the gap between pendulum assemblies 1 and 2 will be equal at all times to that between pendulum assemblies 2 and 3, and equal at all times to that between pendulum assemblies 3 and 1, this equal value being capable of varying with the rotation speed of the combustion engine of the vehicle.

According to a first exemplifying embodiment of the invention, there is a single support and each pendulum assembly comprises:

a first and a second pendulum mass spaced axially with respect to one another, the first pendulum mass being arranged axially on a first side of the support and the second pendulum mass being arranged axially on a second side of the support, and

at least one member connecting the first and the second pendulum mass, pairing said masses.

According to a first variant of this first exemplifying embodiment, each pendulum assembly comprises two connecting members pairing the first and the second pendulum mass, each connecting member defining a second raceway interacting respectively with one of the two rolling members guiding the displacement of that pendulum assembly with respect to the support. Each rolling member interacts here with a single second raceway. A region of the periphery of that connecting member, for example a portion of the radially external surface of that connecting member, defines, for example, this second raceway integral with the pendulum assembly. In this case a portion of the periphery of the window in which that connecting member is arranged then defines the first raceway, integral with the support, with which the rolling member interacts in order to guide the displacement of that pendulum assembly with respect to the support.

A connecting member of this kind is, for example, press-fitted via each of its axial ends into an opening configured in one of the pendulum masses. As a variant, the connecting member can be welded via its axial ends onto each pendulum mass. The connecting member can also be bolted or riveted onto each pendulum mass.

According to this first variant of the first exemplifying embodiment of the invention, each rolling member can then be stressed exclusively in compression between the first raceway integral with the support and the second raceway integral with the pendulum assembly, as mentioned above. These raceways interacting with a given rolling member can at least in part radially face each other, i.e. there exist planes, perpendicular to the rotation axis, in which both of those raceways extend.

According to this first variant of the first exemplifying embodiment, that region of one of the two pendulum assemblies with which the interposition member comes into contact can be constituted by a portion of one of the connecting members of that pendulum assembly, and that portion of the other of the two pendulum assemblies with which the interposition member comes into contact can be constituted by a portion of one of the connecting members of the other of the two pendulum assemblies. In such a case each connecting member comes into contact on the one hand with a rolling member and into contact on the other hand with an interposition member.

According to this first variant of the first exemplifying embodiment of the invention, and alternatively to what is stated immediately above, that region of one of the two pendulum assemblies with which the interposition member comes into contact can be constituted by a portion of the circumferential end respectively of the first or second pendulum mass of one of the two pendulum assemblies, and that region of the other of the two pendulum assemblies with which the interposition member comes into contact can be constituted by a portion of the circumferential end respectively of the first or second pendulum mass of the other of the two pendulum assemblies, those circumferential ends facing each other. In this case the interposition member can come into contact with the pendulum masses directly, and not indirectly via a connecting member pairing those pendulum masses.

According to this alternative to the first variant, each interposition member can then extend in a window over an axial dimension allowing it to come into contact with

the first and second pendulum masses of one of the two pendulum assemblies, and

the first and second pendulum masses of the other of the two pendulum assemblies.

Alternatively, still according to this first variant, the interposition member comes into contact only with the first pendulum mass of one of the two pendulum assemblies and with the first pendulum mass of the other of the two pendulum assemblies. As a further alternative, the interposition member comes into contact only with the second pendulum mass of one of the two pendulum assemblies and with the second pendulum mass of the other of the two pendulum assemblies.

According to a second variant of the first exemplifying embodiment of the invention, there is still one support and each rolling member interacts with two second raceways integral with the pendulum assembly, one of those second raceways being defined by the first pendulum mass and the other of those second raceways being defined by the second pendulum mass.

According to this second variant, that region of one of the two pendulum assemblies with which the interposition member comes into contact is constituted by a portion of the circumferential end respectively of the first or second pendulum mass of one of the two pendulum assemblies, and that region of the other of the two pendulum assemblies with which the interposition member comes into contact is constituted by a portion of the circumferential end respectively of the first or second pendulum mass of the other of the two pendulum assemblies, those circumferential ends facing each other.

According to this second variant each connecting member is, for example, a rivet. The rivet can be received in a window of the support in which a rolling member is already received. As before, a portion of the periphery of the window then defines the first raceway integral with the support.

According to this second variant of the first exemplifying embodiment of the invention, each rolling member can comprise, axially successively:

a region arranged in a cavity of the first pendulum mass and interacting with the second raceway constituted by a portion of the periphery of that cavity;

a region arranged in a window of the support and interacting with the first raceway constituted by a portion of the periphery of that window; and

a region arranged in a cavity of the second pendulum mass and interacting with the second raceway constituted by a portion of the periphery of that cavity.

Similarly to what has been mentioned previously, according to this second variant each interposition member can then extend in a window along an axial dimension allowing it to come into contact with

the first and second pendulum masses of one of the two pendulum assemblies, and

the first and second pendulum masses of the other of the two pendulum assemblies.

Alternatively, the interposition member comes into contact only with the first pendulum mass of one of the two pendulum assemblies and with the first pendulum mass of the other of the two pendulum assemblies. As another alternative and still according to this second variant, the interposition member comes into contact only with the second pendulum mass of one of the two pendulum assemblies and with the second pendulum mass of the other of the two pendulum assemblies.

According to a second exemplifying embodiment of the invention, the device comprises two distinct, axially offset, integral supports, each pendulum assembly comprising at least one pendulum mass, in particular a single pendulum mass or several pendulum masses that are preferably integral, arranged axially between the two supports. The pendulum mass is then sandwiched axially between the two supports. The two supports are, for example, integrated via a connection such as a rivet join, positioned radially internally with respect to the pendulum assemblies.

Two covers can then be positioned axially around the assemblage constituted by the two supports and the pendulum assemblies. The following can then be encountered, axially successively:

one of the covers;

one of the supports;

the pendulum mass or masses;

the other of the supports; and

the other of the covers.

According to a first variant of this second exemplifying embodiment of the invention, each pendulum assembly has a projection projecting axially into a window of one of the supports, this projection defining a second raceway integral with the pendulum assembly.

Two projections can be provided on each side of a pendulum mass or of the integral assemblage of pendulum masses, and those projections can extend axially in opposite directions on either side of the pendulum mass or of that integral assemblage of pendulum masses, and can be axially superposed. The two projections configured on a first side of the pendulum mass or of the integral assemblage of pendulum masses then project into two different windows of one of the supports, while the two projections configured on a second side, opposite to the first side, of the pendulum mass or of the integral assemblage of pendulum masses then project into two different windows of the other of the supports.

The displacement of a pendulum assembly with respect to the support can be guided here by four rolling members:

a first rolling member interacting with a first raceway defined by a portion of the periphery of one of the windows configured in the support arranged on the first side of the pendulum mass or of the assemblage of integral pendulum masses, and with a second raceway defined by one of the projections configured on that first side of the pendulum mass or of the assemblage of integral pendulum masses;

a second rolling member interacting with a first raceway defined by a portion of the periphery of another window configured in the support arranged on the first side of the pendulum mass or of the integral assemblage of pendulum masses, and with a second raceway defined by another of the projections configured on that first side of the pendulum mass or of the integral assemblage of pendulum masses;

a third rolling member interacting with a first raceway defined by a portion of the periphery of one of the windows configured in the support arranged on the second side of the pendulum mass or of the integral assemblage of pendulum masses, and with a second raceway defined by one of the projections configured on that second side of the pendulum mass or of the integral assemblage of pendulum masses; and

a fourth rolling member interacting with a first raceway defined by a portion of the periphery of another window configured in the support arranged on the second side of the pendulum mass or of the integral assemblage of pendulum masses, and with a second raceway defined by another of the projections configured on that second side of the pendulum mass or of the integral assemblage of pendulum masses.

Each of these four rolling members can be loaded only in compression, as explained with reference to the first exemplifying embodiment of the invention.

According to this first variant, that region of one of the two pendulum assemblies with which the interposition member comes into contact can be constituted by a portion of the projection of that pendulum assembly, and that region of the other of the two pendulum assemblies with which the interposition member comes into contact can be constituted by a portion of the projection of that other of the two pendulum assemblies.

In this case two distinct interposition members can be provided between two circumferentially adjacent pendulum assemblies. One of these interposition members is then arranged on the first side of the pendulum masses and can come into contact

with a region of an edge of the window into which a projection of one of the two pendulum assemblies and a projection of the other of the two pendulum assemblies project axially, and

with those two aforementioned projections.

Still in this case, the other of these two interposition members is arranged on the second side of the pendulum masses, and it can come into contact

with a region of an edge of the window into which another projection of one of the two pendulum assemblies and another projection of the other of the two pendulum assemblies project axially, and

with those two aforementioned projections.

As an alternative to this first variant, that region of one of the two pendulum assemblies with which the interposition member comes into contact can be constituted by a portion of the circumferential end of the pendulum mass or of the integral assemblage of pendulum masses of that pendulum assembly, and that region of the other of the two pendulum assemblies with which the interposition member comes into contact can be constituted by a portion of the circumferential end of the pendulum mass or of the integral assemblage of pendulum masses of that other pendulum assembly, those circumferential ends facing each other. In this case a single interposition member can then be provided between two circumferentially adjacent pendulum assemblies.

According to this first variant, each pendulum mass or each integral assemblage of pendulum masses is then not traversed by a rolling member.

According to a second variant of this second exemplifying embodiment of the invention, the pendulum mass has at least two passthrough cavities, so that each rolling member is received

in a window configured in one of the two supports,

in a cavity configured in the pendulum mass or in each of the masses of the integral assemblage of pendulum masses, and

in a window configured in the other of the two supports,

that region of one of the two pendulum assemblies with which the interposition member comes into contact being constituted by a portion of the circumferential end of the pendulum mass or of the integral assemblage of pendulum masses of one of the two pendulum assemblies, and that region of the other of the two pendulum assemblies with which the interposition member comes into contact being constituted by a portion of the circumferential end of the pendulum mass or of the integral assemblage of pendulum masses of the other of the two pendulum assemblies, those circumferential ends facing each other.

According to this second variant, each interposition member interacts with the two supports and with two circumferentially adjacent pendulum assemblies.

In all of the above, each interposition member can exhibit, in a plane perpendicular to the rotation axis of the support, an internal region made of a first material and an external region made of a second material different from the first material. The second material is, for example, more rigid than the first material. Since the first material is not in contact with the support and with the two pendulum assemblies because it defines the core of that interposition member, a material lighter and/or less rigid than the second material can be selected in order to implement it. The inertia of the interposition members, and thus the noise associated with impacts experienced by them, can thus be reduced.

In all of the above, each interposition member can extend axially and can have a cross section of constant radius over its entire length.

As a variant, in all of the above and in particular in the second variant of the second exemplifying embodiment of the invention, each interposition member can extend axially and can successively comprise at least two regions having cross sections of different diameters. Each interposition member comprises, for example, axially successively:

a cylindrical region having a first diameter,

a cylindrical region having a second diameter greater than the first diameter, and

a cylindrical region having the first diameter.

An interposition member of this kind, which can be referred to as “stepped,” advantageously is lossproof in nature.

In all of the above, the device for damping torsional oscillations can be configured in such a way that the displacement of the pendulum assemblies allows filtering of the excitation order of the combustion engine of the vehicle into which the device is integrated, that combustion engine in particular having two or three cylinders.

In all of the above, the device comprises, for example, a number of pendulum assemblies between two and eight, in particular three or six pendulum assemblies. All these pendulum assemblies can be circumferentially successive. The device can thus comprise a plurality of planes, perpendicular to the rotation axis, in each of which all the pendulum assemblies are arranged.

In all of the above, each support can be implemented as a single part, for example being entirely metallic.

In all of the above, the device can comprise at least one interposition part at least a portion of which is arranged axially between a support and a pendulum mass of the pendulum assembly. An interposition part of this kind can thus limit the axial displacement of the pendulum assembly with respect to the support, thus preventing axial impacts between said parts and thus undesirable wear and noise, especially when the support and/or the pendulum mass are made of metal. Several interposition parts, for example in the form of sliders, can be provided. The interposition parts are made in particular of a damping material such as plastic or rubber.

The interposition parts are, for example, carried by the pendulum assemblies. The interposition parts can be positioned on a pendulum assembly in such a way that there is always at least one interposition part at least a portion of which is interposed axially between a pendulum mass and the support, regardless of the relative positions of the support and of said mass in the context of displacement of the pendulum assembly with respect to the support.

In all of the above, the device can comprise:

at least one first pendulum assembly allowing a first order value of the torsional oscillations to be filtered, and

at least one second pendulum assembly allowing a second order value of the torsional oscillations, different from the first order value, to be filtered.

In all of the above, each window can receive only two rolling members.

A further object of the invention is a device for damping torsional oscillations, comprising:

at least one support capable of rotational displacement around an axis;

a plurality of pendulum assemblies, each pendulum assembly being movable with respect to the support;

a plurality of rolling members, each rolling member interacting with a first raceway integral with the support and with a second raceway integral with a pendulum assembly, the displacement of each pendulum assembly with respect to the support being guided by at least two of those rolling members; and

a plurality of interposition members,

the support comprising a plurality of windows in each of which two rolling members are received, one of those rolling members interacting with a second raceway integral with one of the pendulum assemblies, and the other of those rolling members interacting with a second raceway integral with another of those pendulum assemblies, said pendulum assemblies being circumferentially adjacent;

each interposition member being arranged in a window and being freely displaceable in the latter in such a way as to be continuously interposed between the two pendulum assemblies guided by the two rolling members received in that window.

All or some of the characteristics above also apply to this other aspect of the invention.

A further object of the invention, according to another of its aspects, is a device for damping torsional oscillations, comprising:

at least one support capable of rotational displacement around an axis;

a plurality of pendulum assemblies, each pendulum assembly being movable with respect to the support;

a plurality of rolling members, each rolling member interacting with a first raceway integral with the support and with a second raceway integral with a pendulum assembly, the displacement of each pendulum assembly with respect to the support being guided by at least two of those rolling members; and

a plurality of abutment damping members movable with respect to the support and to each pendulum assembly,

the support comprising a plurality of windows in each of which two rolling members are received, one of those rolling members interacting with at least one second raceway integral with one of the pendulum assemblies, and the other of those rolling members interacting with at least one second raceway integral with another of those pendulum assemblies, said pendulum assemblies being circumferentially adjacent;

each abutment damping member being received in one of those windows.

Each abutment damping member interacts, for example, with the radially internal edge of the window and with at least one of the pendulum assemblies in order to damp its or their abutment against the support. Each abutment damping member can interact with the aforementioned cavities in that radially internal edge of the window.

Each abutment damping member is, in particular, capable of compressing upon contact with that radially internal edge of the window. Each abutment damping member is, in particular, capable of coming into contact simultaneously with the radially internal edge of the window and with each pendulum assembly guided by a rolling member received in that window. That abutment damping member can be freely displaceable in the window, its displacement in the window being, for example, limited only the occurrence of contact with that edge of the window and with the pendulum assemblies.

All or some of the characteristics mentioned above also apply to this other aspect of the invention, in particular the fact that only one abutment damping member is received in each window configured in the support.

A further object of the invention in accordance with another of its aspects is a component for a transmission system of a motor vehicle, the component being in particular a dual mass flywheel, a hydrodynamic torque converter, or a friction clutch disk, or a dry or wet dual clutch or a wet single clutch or a flywheel integral with a crankshaft, or a component forming part of a hybrid drive train, comprising a device as defined above for damping torsional oscillations.

The support of the device for damping torsional oscillations can then be one among:

a web of the component;

a guide washer of the component;

a phase washer of the component; or

a support distinct from said web, said guide washer, and said phase washer.

A further object of the invention in accordance with another of its aspects is a vehicle drive train, comprising:

a combustion engine for vehicle propulsion, in particular having two, three, or four cylinders; and

a transmission system component as defined above.

### BRIEF DESCRIPTION OF THE DRAWINGS

A better understanding of the invention will be gained from reading the description below of non-limiting exemplifying embodiments thereof, and from an examination of the attached drawings, in which:

FIG. 1 depicts a device for damping torsional oscillations according to a first variant of a first exemplifying embodiment of the invention;

FIG. 2 shows a detail of the device of FIG. 1;

FIGS. 3 to 6 depict various alternatives to what is depicted in FIG. 2;

FIG. 7 depicts a device for damping torsional oscillations according to a second variant of the first exemplifying embodiment of the invention;

FIG. 8 depicts a device for damping torsional oscillations according to a first variant of a second exemplifying embodiment of the invention;

FIGS. 9 and 10 are section views, respectively along IX-IX and X-X, of the device depicted in FIG. 8;

FIG. 11 depicts a device for damping torsional oscillations according to a second variant of a second exemplifying embodiment of the invention; and

FIGS. 12 and 13 are section views, respectively along XII-XII and XIII-XIII, of the device depicted in FIG. 11.

### DETAILED DESCRIPTION OF THE PREFERRED EMBODIMENT(S)

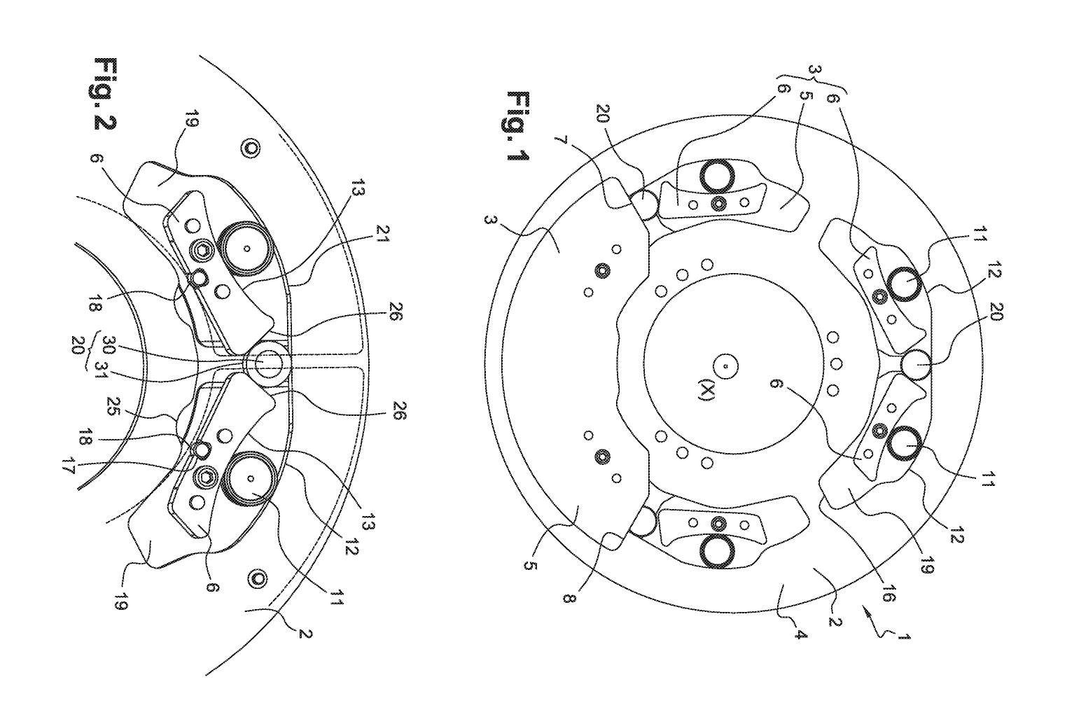

FIG. 1 depicts a device 1 for damping torsional oscillations, according to a first variant of a first exemplifying embodiment of the invention.

Damping device 1 is of the pendulum oscillator type. Device 1 is capable in particular of being part of a motor vehicle transmission system, for example being integrated into a component (not depicted) of such a transmission system, that component being, for example, a dual mass flywheel, a hydrodynamic torque converter, or a clutch disk.

That component can be part of a drive train of a motor vehicle, that drive train comprising a combustion engine having in particular two, three, or four cylinders.

In FIG. 1 device 1 is inactive, i.e. it is not filtering the torsional oscillations transmitted by the drive train due to irregularities of the combustion engine.

In known fashion, such a component can comprise a torsional damper exhibiting at least one input element, at least one output element, and circumferentially acting elastic return members that are interposed between said input and output elements. For purposes of the present Application the terms “input” and “output” are defined with respect to the direction of torque transmission from the combustion engine of the vehicle toward the latter's wheels.

In the example considered, device 1 comprises:

a support 2 capable of rotational displacement around an axis X; and

a plurality of pendulum assemblies 3 movable with respect to support 2.

In the example considered, three pendulum assemblies 3 are provided, being distributed uniformly around the periphery of axis X.

Support 2 of damping device 1 can be constituted by:

an input element of the torsional damper;

an output element or an intermediate phasing element arranged between two series of springs of the damper; or

an element rotationally connected to one of the aforementioned elements and distinct therefrom, being then, for example, a support specific to device 1.

Support 2 is in particular a guide washer or a phase washer. The support can also be different, for example a flange of the component.

In the example considered, support 2 is globally in the shape of a ring having two opposite sides 4 that here are planar faces.

As is evident in particular from FIGS. 4 and 5, in the example considered each pendulum assembly 3 comprises:

two pendulum masses 5, each pendulum mass 5 extending axially facing one side 4 of support 2; and

two connecting members 6 integrating the two pendulum masses 5.

FIG. 1 depicts two pendulum assemblies 3 in incomplete fashion, one of pendulum masses 5 not being depicted in the interest of graphic clarity.

In the example considered, connecting members 6, also called “spacers,” are angularly offset. Each assembly 3 extends angularly between two circumferential ends that correspond respectively to circumferential ends 7 and 8 of pendulum masses 5 of that assembly.

In the example of FIGS. 1 to 6, each connecting member is bolted onto one of pendulum masses 5 in order to integrate the latter with one another. In an alternative that is not depicted, each end of a connecting member 6 is press-fitted into an opening configured in one of pendulum masses 5 of pendulum assembly 3 in order to integrate those two pendulum masses 5 with one another.

In yet another alternative, each end of a connecting member 6 is integrated with one of pendulum masses 5 by welding.

In yet another alternative, each connecting member is riveted to one of pendulum masses 5.

Device 1 also comprises rolling members 11 guiding the displacement of pendulum assemblies 3 with respect to support 2. Rolling members 11 here are rollers.

In the example described, the motion of each pendulum assembly 3 with respect to support 2 is guided by two rolling members 11. This motion is, for example, a combined motion.

Each rolling member 11 is received in a window 19 configured in support 2. As depicted in the Figures, two rolling members 11 associated with two different and circumferentially adjacent pendulum assemblies 3 are received in the same window 19 configured in support 2. In other words, the following are received inside the same window 19:

a rolling member 11 guiding the displacement of a pendulum assembly 3, and

a rolling member 11 guiding the displacement of another pendulum assembly 3 that is circumferentially adjacent.

Each window 19 has a continuous periphery 16, and a portion of that periphery 16 defines a first raceway 12, integral with support 2, on which one of rolling members 11 received in that window will roll, while another portion of that continuous periphery 16 defines another first raceway 12, integral with support 2, on which the other rolling member 11 received in window 19 will roll.

In the example of FIGS. 1 to 6, each window 19 furthermore receives

a connecting member 6 of a pendulum assembly 3, and

a connecting member 6 of another pendulum assembly 3 that is circumferentially adjacent.

In the example of FIGS. 1 to 6, each connecting member 6 defines a second raceway 13 that is integral with pendulum assembly 3 to which that connecting member 6 belongs and on which one of rolling members 11 rolls in order to guide the displacement of that pendulum assembly 3 with respect to support 2.

Each connecting member has on its radially internal edge a notch 17 in which an abutment damper 18, for example made of elastomer or of rubber, is received.

As is evident from FIGS. 1 to 6, each window 19 furthermore receives an interposition member 20. This interposition member 20 is arranged in window 19 so as to become interposed between the two pendulum assemblies 3 whose displacement with respect to support 2 is guided by a rolling member 11 received in that window 19.

Each interposition member 20 here has a circular cross section, like each rolling member 11.

As is evident from FIGS. 1 to 6, each interposition member 20 is mounted freely in a window 19, and that interposition member 20 is capable of coming into contact

on the one hand with a region of periphery 16 of window 19,

on the other hand with an edge of a region of one of the two pendulum assemblies 3, and

on the other hand with an edge of a region of the other of the two pendulum assemblies 3.

This interposition member 20 thus allows a minimum non-zero gap to exist continuously between those two circumferentially adjacent pendulum assemblies 3.

In FIGS. 1 to 4, device 1 is inactive and interposition member 20 comes into contact with the edge of the region of one of the two pendulum assemblies 3 and with the edge of the region of the other of the two pendulum assemblies 3, while a clearance exists between interposition member 20 and the region of periphery 16 of window 19.

When a torsional oscillation is being filtered by pendulum assemblies 3, the latter are displaced around rotation axis X of support 2 and, as appropriate, around their center of gravity. Such a displacement of pendulum assemblies 3 is transmitted to interposition members 20 that roll along said region of periphery 16 of window 19 and along a region belonging to one of the two pendulum assemblies 3 between which they are interposed. This interaction between interposition members 20 and pendulum assemblies 3 allows a minimum distance between the two pendulum assemblies 3 to be maintained by way of interposition members 20. In the context of this displacement, each interposition member 20 can come into contact simultaneously with region 19 of periphery 16 of the window, with the region belonging to one of the two pendulum assemblies 3, and with the region belonging to the other of pendulum assemblies 3.

In the example of FIGS. 1 to 4, the region of periphery 16 of window 19 of support 2 with which interposition member 20 comes into contact, and along which it can roll, belongs to radially external edge 21 of window 19.

Interposition member 20 then comes into contact simultaneously with that region of edge 21, with the edge of the region of one of the two pendulum assemblies 3, and with the edge of the region of the other of the two pendulum assemblies 3, intermittently when a torsional oscillation is being filtered.

In the example of FIGS. 1 to 3, that region of one of the two pendulum assemblies 3 along which interposition member 20 rolls is constituted by a portion of one of connecting members 6 of that pendulum assembly, and that region of the other of the two pendulum assemblies along which interposition member 20 rolls is constituted by a portion of one of connecting members 6 of the other of the two pendulum assemblies 3. This portion of a connecting member 6 is here a part of its lateral surface 26.

Each connecting member 6 thus exhibits

a radially external surface, a region of which defines a second raceway 13, and

a lateral surface 26, a part of which interacts with an interposition member 20 by rolling.

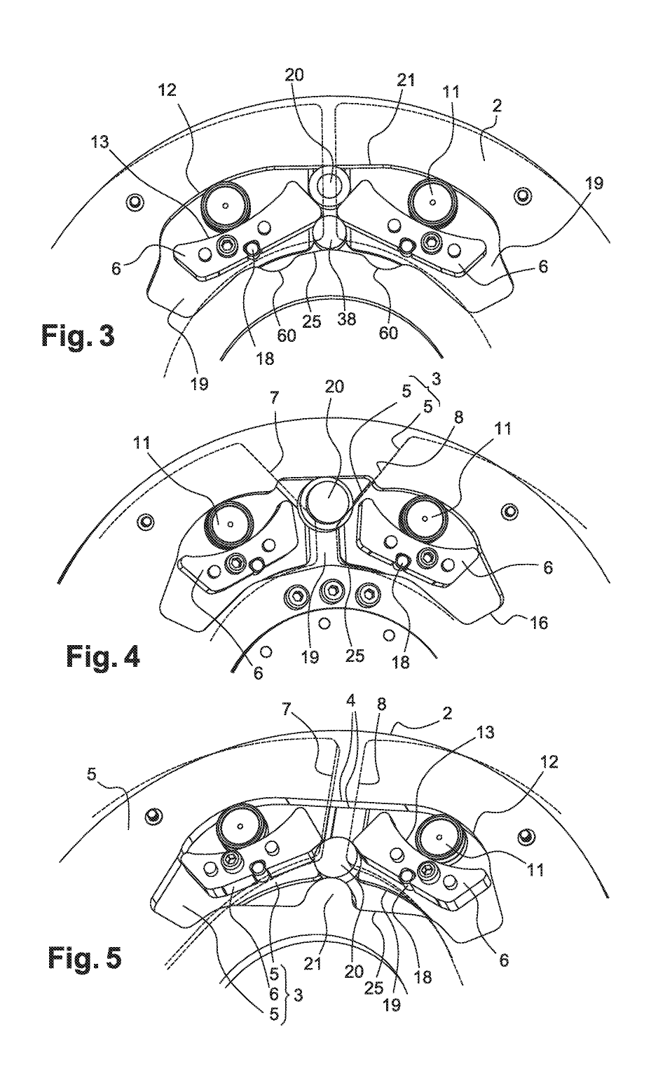

As is evident from FIGS. 2 and 3, in which one pendulum mass 5 of each pendulum assembly 3 is depicted as transparent, the interposition member can then be arranged partly inside a pendulum assembly in the space left open by the fact that pendulum masses 5 of a pendulum assembly 3 extend angularly beyond connecting members 6.

In the example of FIGS. 1 to 3, each interposition member 20 comprises only one single diameter over its entire length.

In the example of FIGS. 2 and 3, each interposition member 20 is implemented from two materials. Core 30 of this interposition member is made of a first material distinct from the second material that is used to implement external region 31 of that interposition member 20, The first material is, for example, lighter than the second material.

In the example of FIG. 3, an abutment damping member 38 is provided in each window 19. This abutment damping member 38 is arranged radially between radially internal edge 25 of window 19 and interposition member 20, and it has a cylindrical cross section.

This abutment damping member 38 is implemented from rubber or elastomer, and it is capable of compressing upon contact with radially internal edge 25 of window 19. This damping member 38 can thus interact with the aforementioned abutment damper 18 in order to damp impacts associated with pendulum assembly 3 coming into abutment against support 2.

As is evident from FIG. 3, in the example described this abutment damping member 38 is not integral either with pendulum assemblies 3 or with support 2 or with interposition member 20. Abutment damping member 38, for example, comes into contact simultaneously with radially internal edge 25 of window 19, with interposition member 20, and with each pendulum assembly 3 as it damps the abutment of those pendulum assemblies 3 against support 2.

In the example of FIG. 3, two cavities 60 are configured in radially internal edge 25 of window 19, and each of these cavities 60 has a dimension allowing it to accommodate abutment damping member 38. In the example considered, each cavity is arranged radially between rotation axis X and one of rolling members 11 received in window 19 when device 1 is inactive.

One of cavities 60 accommodates abutment damping member 38 upon abutment of pendulum assemblies 3 against support 2 subsequent to a counter-clockwise displacement of those pendulum assemblies 3 in order to filter a torsional oscillation, while the other cavity 60, configured in radially internal edge 25 of window 19, accommodates abutment damping member 38 upon abutment of pendulum assemblies 3 against support 2 subsequent to a clockwise displacement of those pendulum assemblies 3 in order to filter a torsional oscillation.

Abutment damping member 38 is freely displaceable in window 19, its displacement in that window 19 here being limited only by the occurrence of contacts with that edge 25 of window 19, with pendulum assemblies 3, and with interposition member 20.

In the example of FIG. 4, that region of one of the two pendulum assemblies 3 along which interposition member 20 rolls is constituted by a portion of circumferential end 7 of first pendulum mass 5 and by a portion of circumferential end 7 of second pendulum mass 5 of one of those two pendulum assemblies 3.

Still in this example, that region of the other of the two pendulum assemblies 3 along which interposition member 20 rolls is constituted by a portion of circumferential end 8 of first pendulum mass 5 and by a portion of circumferential end 8 of second pendulum mass 5 of the other of those two pendulum assemblies 3. In the example of FIG. 4, each interposition member 20 thus extends in a window 19 over an axial dimension that allows it to come into contact with

first and second pendulum masses 5 of one of the two pendulum assemblies 3, and

first and second pendulum masses 5 of the other of the two pendulum assemblies 3.

In the example of FIG. 4, each interposition member has several distinct diameters successive to one another. The median region of interposition member 20 thus has a diameter greater than that of the end regions.

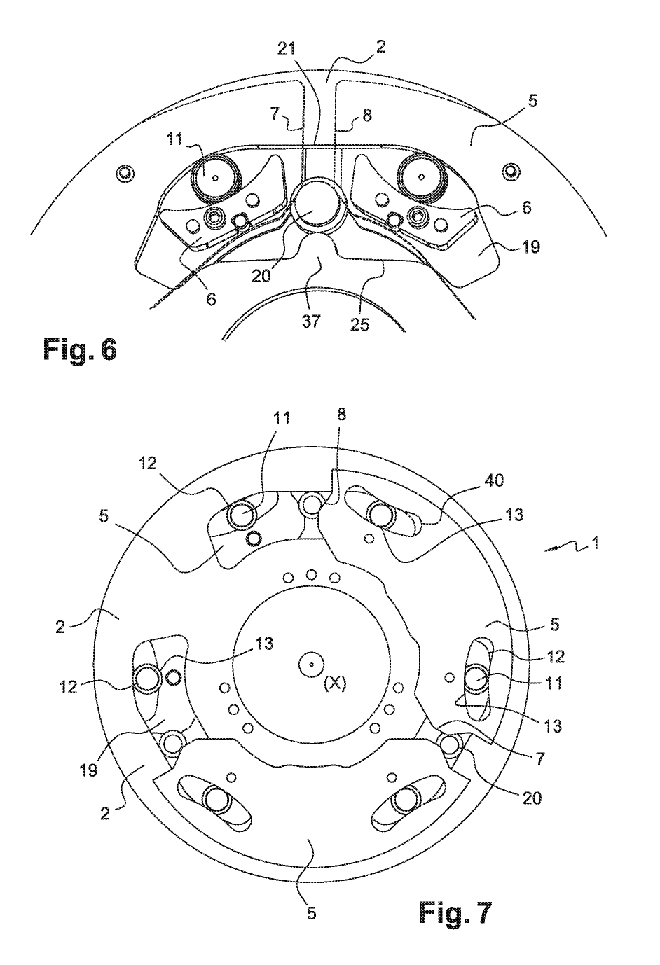

In the example of FIGS. 5 and 6, each interposition member 20 is capable of coming into contact with radially internal edge 25 of window 19, and of rolling along a region of that edge 25 when pendulum assemblies 3 are displaced due to a torsional oscillation experienced by device 1. Interposition member 20 then comes into contact simultaneously with that region of edge 25, with one of the two pendulum assemblies 3, and with the other of the two pendulum assemblies 3, at least when the combustion engine of the vehicle is stopped.

As is evident in particular from FIGS. 5 and 6, radially internal edge 25 of window 19 can define a protrusion 37 projecting radially into window 19, and interposition member 20 rests against that protrusion when the combustion engine of the vehicle is stopped. This protrusion 37 has a rounded shape in the plane of FIG. 6, and this shape is selected so that interposition member 20 remains at a constant distance from the edge of that protrusion as it is displaced in window 19 in response to the displacement of the two pendulum assemblies 3, as long as the latter are not desynchronized.

In the example of FIG. 5, similarly to what was described with reference to FIGS. 1 to 3, that region of one of the two pendulum assemblies 3 along which interposition member 20 rolls is constituted by a portion of one of connecting members 6 of that pendulum assembly, and that portion of the other of the two pendulum assemblies along which interposition member 20 rolls is constituted by a portion of one of connecting members 6 of the other of the two pendulum assemblies 3. This portion of a connecting member 6 here is a part of its radially internal surface.

Each interposition member 20 is therefore capable of coming into contact, simultaneously or not, with

a part of the radially internal surface of a connecting member 6 of one of the two pendulum assemblies 3,

a part of the radially internal surface of a connecting member 6 of another of the two pendulum assemblies 3, and

a region of the radially internal edge 25 of window 19.

In the example of FIG. 6, similarly to what was described with reference to FIG. 4, that region of one of the two pendulum assemblies 3 along which interposition member 20 rolls is constituted by a portion of circumferential end 7 of first pendulum mass 5 and by a portion of circumferential end 7 of second pendulum mass 5 of one of those two pendulum assemblies 3. Still in this example, that region of the other of the two pendulum assemblies along which interposition member 20 rolls is constituted by a portion of circumferential end 8 of first pendulum mass 5 and by a portion of circumferential end 8 of second pendulum mass 5 of the other of those two pendulum assemblies 3.

Each interposition member 20 is therefore capable of coming into contact, simultaneously or not, with

a part of circumferential end 7 of first pendulum mass 5 and of circumferential end 7 of second pendulum mass 5 of one of the two pendulum assemblies 3,

a part of circumferential end 8 of first pendulum mass 5 and of circumferential end 8 of second pendulum mass 5 of the other of the two pendulum assemblies 3, and

a region of radially internal edge 25 of window 19.

According to a second variant of the first exemplifying embodiment of the invention which is depicted in FIG. 7, each rolling member 11 interacts with two distinct second raceways 13 integral with a pendulum assembly 3. One of pendulum assemblies 3 is not depicted in its entirety in FIG. 7.

One of second raceways 13 is defined by first pendulum mass 5 of pendulum assembly 3, and the other of these second raceways 13 is defined by second pendulum mass 5 of that pendulum assembly 3. In this example each pendulum mass 5 has two cavities 40, and each of cavities 40 receives a portion of a rolling member 11 which interacts with second raceway 13 constituted by a portion of the periphery of that cavity 40. First raceway 12 with which that rolling member 11 interacts is, as previously, constituted by a portion of periphery 16 of window 19.

In the example of FIG. 7, each connecting member 6 is a rivet that is also received in window 19.

As is evident from this FIG. 7, that region of one of the two pendulum assemblies 3 along which interposition member 20 rolls is constituted by a portion of circumferential end 7 of first pendulum mass 5 and by a portion of circumferential end 7 of second pendulum end 5 of that pendulum assembly 3, and that region of the other of the two pendulum assemblies 3 along which interposition member 20 rolls is constituted by a portion of circumferential end 8 of the first pendulum mass and by a portion of circumferential end 8 of second pendulum mass 5 of that other pendulum assembly 3, and those circumferential ends 7 and 8 face each other.

Similarly to what has been mentioned previously, each interposition member 20 of the example of FIG. 7 can extend in a window 19 over an axial dimension allowing it to come into contact with

first and second pendulum masses 5 of one of the two pendulum assemblies 3, and

first and second pendulum masses 5 of the other of the two pendulum assemblies 3.

As a variant, the interposition member comes into contact only with the first pendulum mass of one of the two pendulum assemblies and with the first pendulum mass of the other of the two pendulum assemblies. As a further variant, the interposition member comes into contact only with the second pendulum mass of one of the two pendulum assemblies and with the second pendulum mass of the other of the two pendulum assemblies.

FIGS. 1 to 7 relate to the first exemplifying embodiment of the invention, according to which device 1 comprises a single support and each pendulum assembly 3 comprises two pendulum masses that are paired and each extend on one side 4 of support 2.

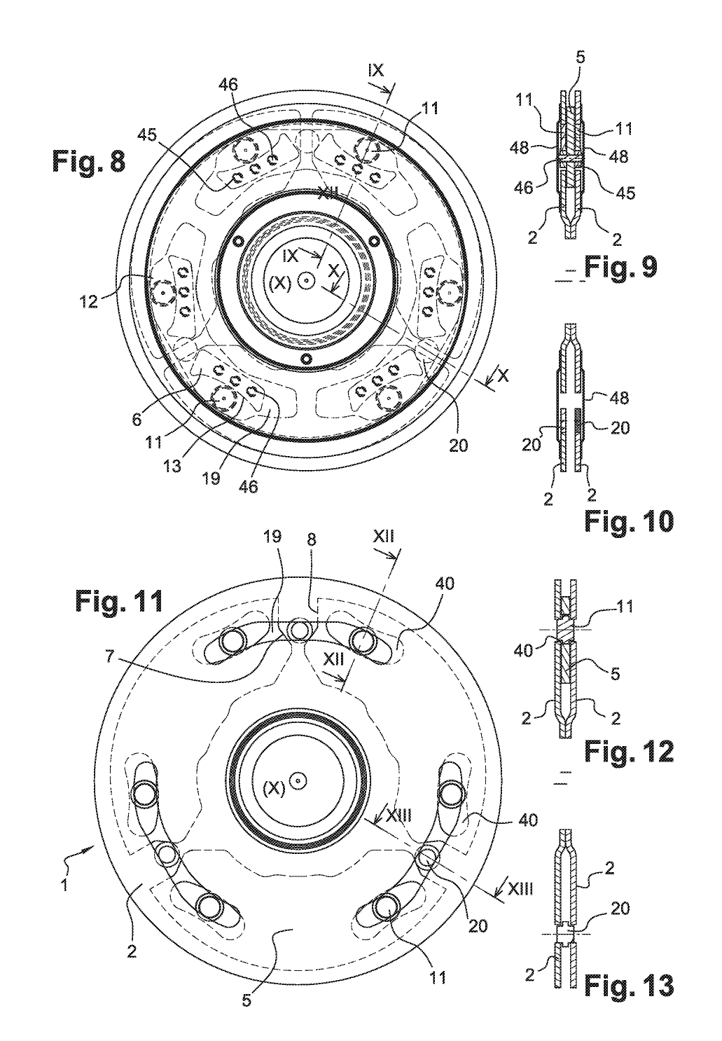

Two variants of a device for damping torsional oscillations according to a second exemplifying embodiment of the invention will now be described with reference to FIGS. 8 to 13.

According to this second exemplifying embodiment of the invention, the device comprises two distinct, axially offset, integral supports 2. Each pendulum assembly 3 furthermore comprises, in the example described, a single pendulum mass 5 arranged axially between the two supports 2.

In the example of FIGS. 8 to 10, two covers 48 are positioned axially around the assemblage constituted by the two supports 2 and by pendulum assemblies 3, so that the following are encountered, axially successively:

one of covers 48;

one of supports 2;

a pendulum mass 5;

the other of supports 2; and

the other of covers 48.

According to a first variant of this second exemplifying embodiment of the invention which is depicted in FIGS. 8 to 10, each pendulum assembly 3 has a projection 45 projecting axially into a window 19 of one of supports 2. This projection 45, which can be implemented, or not, as a single part with pendulum mass 5 of pendulum assembly 3, here defines a second raceway 13 integral with the pendulum assembly.

In the example depicted in FIGS. 8 to 10, two projections 45 are provided on each side of a pendulum mass 5. On either side of pendulum mass 5, these projections here extend axially in opposite directions and they are axially superposed. Two axially superposed projections 45 can be connected together and to pendulum mass 5 via rivets 46, as depicted in FIGS. 8 and 9.

As is apparent from FIG. 9, the two projections 45 configured on a first side of pendulum mass 5 then project into two different windows 19 of one of supports 2, while the two projections 45 configured on a second side of pendulum mass 5, opposite to the first side, then project into two different windows 19 of the other of the two supports 2 of device 1.

In the example considered, the displacement of each pendulum assembly 3 with respect to support 2 is guided by four distinct rolling members 11:

a first rolling member 11 interacting with a first raceway 12 defined by a portion of the periphery of one of windows 19 configured in support 2 arranged on the first side of pendulum mass 5, and with a second raceway 13 defined by one of projections 45 configured on that first side of pendulum mass 5;

a second rolling member 11 interacting with a first raceway 12 defined by a portion of the periphery of another window 19 configured in support 2 arranged on the first side of pendulum mass 5, and with a second raceway 13 defined by another of projections 45 configured on that first side of pendulum mass 5;

a third rolling member 11 interacting with a first raceway 12 defined by a portion of the periphery of one of windows 19 configured in support 2 arranged on the second side of pendulum mass 5, and with a second raceway 13 defined by one of projections 45 configured on that second side of pendulum mass 5; and

a fourth rolling member 11 interacting with a first raceway 12 defined by a portion of the periphery of another window 19 configured in support 2 arranged on the second side of pendulum mass 5, and with a second raceway 13 defined by another of projections 45 configured on that second side of pendulum mass 5.

In the example of FIGS. 8 to 10, that region of one of the two pendulum assemblies 3 along which an interposition member 20 rolls is constituted by a portion of projection 45 of that pendulum assembly 3, and that region of the other of the two pendulum assemblies 3 with which interposition member rolls is constituted by a portion of projection 45 of that other of the two pendulum assemblies 3. Each projection 45 can thus interact on the one hand with a rolling member 11 via a region of its radial external surface which defines a second raceway 13, and on the other hand with an interposition member 20 via a part of its lateral surface.

Still in this example, and as depicted in FIG. 10, two distinct interposition members 20 are provided between two circumferentially adjacent pendulum assemblies 3. One of these interposition members 20 is arranged on the first side of pendulum masses 5, and it can come into contact

with a region of an edge of window 19 into which a projection 45 of one of the two pendulum assemblies 3, and a projection 45 of the other of the two pendulum assemblies 3, project axially, and

with those two projections 45.

Still in this case, the other of those interposition members 20 is arranged on the second side of pendulum masses 5.

FIGS. 11 to 13 depict a second variant of this second exemplifying embodiment of the invention.

According to this second variant, each pendulum mass 5 exhibits at least two passthrough cavities 40, so that each rolling member 11 is received

in a window 19 configured in one of the two supports 2,

in a cavity 40 configured in pendulum mass 5, and

in a window 19 configured in the other of the two supports 2.

According to this second variant, that region of one of the two pendulum assemblies 3 with which the interposition member comes into contact is constituted by a portion of circumferential end 7 of pendulum mass 5 of one of the two pendulum assemblies 3, and that region of the other of the two pendulum assemblies 3 along which interposition member 20 rolls is constituted by a portion of circumferential end 8 of pendulum mass 5 of the other of the two pendulum assemblies 3, those circumferential ends 7 and 8 facing each other.

According to this second variant, each interposition member 20 interacts with the two supports 2 and with two circumferentially adjacent pendulum assemblies 3.

The invention is not limited to the examples that have just been described.

For example, characteristics defined with reference to different embodiments can be combined with one another.

By way of example:

a rolling member 11 according to FIGS. 2 and 3 can be used in the devices depicted in FIGS. 4 to 13, or

an interposition member interacting with radially internal edge 25 of a window 19 is also applicable to the devices of FIGS. 7 to 13.

1. A device for damping torsional oscillations (1), comprising:
at least one support (2) capable of rotational displacement around an axis (X);
a plurality of pendulum assemblies (3), each pendulum assembly (3) being movable with respect to the support (2);
a plurality of rolling members (11), each rolling member (11) interacting with a first raceway (12) integral with the support (2) and with a second raceway (13) integral with a pendulum assembly (3), the displacement of each pendulum assembly (3) with respect to the support (2) being guided by at least two of those rolling members (11); and
a plurality of interposition members (20),
the support (2) comprising a plurality of windows (19) in each of which two rolling members (11) are received, one of those rolling members (11) interacting with a second raceway (13) integral with one of the pendulum assemblies (3), and the other of those rolling members (11) interacting with a second raceway (13) integral with another of those pendulum assemblies (3), said pendulum assemblies (3) being circumferentially adjacent;
each interposition member (20) being arranged in a window (19) of the support (2) and being movable with respect to each of the two pendulum assemblies (3) whose displacement with respect to the support (2) is guided by one of the two rolling members (11) received in that window (19), each interposition member (20) being capable of coming into contact
on the one hand with a region of the periphery (16) of the window (19) in which it is received,
on the other hand with a region (6, 7, 8, 45) of one of the two pendulum assemblies (3), and
on the other hand with a region (6, 7, 8, 45) of the other of the two pendulum assemblies (3).

2. The device according to claim 1, wherein each interposition member rolling
on the one hand along the region of the periphery (16) of the window (19) in which it is received,
on the other hand along the region (6, 7, 8, 45) of one of the two pendulum assemblies (3), and
on the other hand along the region (6, 7, 8, 45) of the other of the two pendulum assemblies (3).

3. The device according to claim 1, wherein the center of gravity of each pendulum assembly (3) describes a curve upon its displacement with respect to the support (2) in order to filter a torsional oscillation, and the region (6, 7, 8, 45) of one of the two pendulum assemblies (3) with which the interposition member (20) comes into contact, and the region (6, 7, 8, 45) of the other of the two pendulum assemblies (3) with which the interposition member (20) comes into contact, each defining a curve of the same family as the one described by the center of gravity of each pendulum assembly (3).

4. The device according to claim 1, wherein the interposition member (20) comes into contact simultaneously with the region of the periphery (16) of the window (19), with the region (6, 7, 8, 45) of one of the two pendulum assemblies (3), and with the region (6, 7, 8, 45) of the other of the two pendulum assemblies (3).

5. The device according to claim 2, wherein that region of the periphery (16) of the window (19) of the support (2) with which the interposition member (20) comes into contact belongs to the radially external edge (21) of that window (19).

6. The device according to claim 5, further comprising an abutment damping member (30) arranged radially between the radially internal edge (25) of the window (19) and the interposition member (20), the abutment damping member (30) being capable of compressing upon contact with that radially internal edge (25) of the window (19).

7. The device according to claim 1, wherein that region of the periphery (16) of the window (19) of the support (2) with which the interposition member (20) comes into contact belongs to the radially internal edge (25) of that window (19).

8. The device according to claim 1, wherein there being a single support (2) and each pendulum assembly (3) comprising:
a first and a second pendulum mass (5) spaced axially with respect to one another, the first pendulum mass (5) being arranged axially on a first side (4) of the support (2) and the second pendulum mass (5) being arranged axially on a second side (4) of the support (2), and
at least one member (6) connecting the first and the second pendulum mass (5), pairing said masses.

9. The device according to claim 8, wherein each pendulum assembly (3) comprising two connecting members (6) pairing the first (5) and the second pendulum mass (5), each connecting member (6) defining a second raceway (13) interacting respectively with one of the two rolling members (11) guiding the displacement of that pendulum assembly (3) with respect to the support (2).

10. The device according to claim 9, wherein that region of one of the two pendulum assemblies (3) with which the interposition member (20) comes into contact being constituted by a portion of one of the connecting members (6) of that pendulum assembly, and that portion of the other of the two pendulum assemblies (3) with which the interposition member (20) comes into contact being constituted by a portion of one of the connecting members (6) of the other of the two pendulum assemblies (3).

11. The device according to claim 9, wherein that region of one of the two pendulum assemblies (3) with which the interposition member (20) comes into contact being constituted by a portion of the circumferential end (7) respectively of the first or second pendulum mass (5) of one of the two pendulum assemblies (3), and that region of the other of the two pendulum assemblies (3) with which the interposition member (20) comes into contact being constituted by a portion of the circumferential end (8) respectively of the first or second pendulum mass (5) of the other of the two pendulum assemblies (3), those circumferential ends (7, 8) facing each other.

12. The device according to claim 9, wherein each rolling member (11) interacting with two second raceways (13) integral with the pendulum assembly (3), one of those second raceways (13) being defined by the first pendulum mass (5) and the other of those second raceways (13) being defined by the second pendulum mass (5), that region of one of the two pendulum assemblies (3) with which the interposition member (20) comes into contact being constituted by a portion of the circumferential end (7) respectively of the first or second pendulum mass (5) of one of the two pendulum assemblies (3), and that region of the other of the two pendulum assemblies (3) with which the interposition member (20) comes into contact being constituted by a portion of the circumferential end (8) respectively of the first or second pendulum mass (5) of the other of the two pendulum assemblies (3), those circumferential ends (7, 8) facing each other.

13. The device according to claim 1, further comprising two distinct, axially offset, integral supports (2), each pendulum assembly (3) comprising at least one pendulum mass (5) arranged axially between the two supports (2).

14. The device according to claim 13, wherein each pendulum assembly (3) having a projection (45) projecting axially into a window (19) of one of the supports (2), this projection (45) defining a second raceway (13) integral with the pendulum assembly (3), that region of one of the two pendulum assemblies (3) with which the interposition member (20) comes into contact being constituted by a portion of the projection (45) of that pendulum assembly (3), and that region of the other of the two pendulum assemblies (3) with which the interposition member (20) comes into contact being constituted by a portion of the projection (45) of that other of the two pendulum assemblies (3).

15. The device according to claim 13, wherein the pendulum mass (5) has at least two passthrough cavities (40), so that each rolling member (11) is received
in a window (19) configured in one of the two supports (2),
in a cavity (40) configured in the pendulum mass (5), and
in a window (19) configured in the other of the two supports (2),
that region of one of the two pendulum assemblies (3) with which the interposition member (20) comes into contact being constituted by a portion of the circumferential end (7) of the pendulum mass (5) of one of the two pendulum assemblies (3), and that region of the other of the two pendulum assemblies (3) with which the interposition member (20) comes into contact being constituted by a portion of the circumferential end (8) of the pendulum mass (5) of the other of the two pendulum assemblies (3), those circumferential ends (7, 8) facing each other.

16. The device according to claim 1, wherein each interposition member (20) extends axially and has a cross section of constant radius over its entire length.

17. The device according to claim 1, wherein each interposition member (20) extends axially and exhibits successively at least two regions having cross sections of different diameters.

18. The device according to claim 1, wherein the displacement of the pendulum assemblies (3) configured to allow filtering of the excitation order of a two-cylinder combustion engine of a vehicle.

19. The device according to claim 2, wherein the center of gravity of each pendulum assembly (3) describing a curve upon its displacement with respect to the support (2) in order to filter a torsional oscillation, and the region (6, 7, 8, 45) of one of the two pendulum assemblies (3) with which the interposition member (20) comes into contact, and the region (6, 7, 8, 45) of the other of the two pendulum assemblies (3) with which the interposition member (20) comes into contact, each defining a curve of the same family as the one described by the center of gravity of each pendulum assembly (3).
